(19) United States
(12) Patent Application Publication
(10) Pub. No.: US 2004/0060976 A1
(43) Pub. Date: Apr. 1, 2004

(54) Trusted shipper seal tag with steganographic authentication

(75) Inventors: Richard N. Blazey, Penfield, NY (US); Jerry Carmen, Spencerport, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/256,796

(22) Filed: Sep. 27, 2002

(51) Int. Cl. G06F 17/00

(52) U.S. Cl. 235/375

(57) ABSTRACT

A system is provided for authenticating the identity of a container at an inspection station and for assuring the contents of the container have not been changed during transit, comprising: a copy-protected secure seal tag affixed to the container in such a way that the contents of the container cannot be accessed without altering the seal tag in a detectable way, the seal tag further comprising information hidden information containing a unique code pertaining to the container and a specific shipment of the container; and a device enabled to detect the presence of the hidden information in the seal tag and extract and verify the unique code.

### FIELD OF THE INVENTION

The present invention relates to the secure shipping of authorized cargo. More specifically it relates to a method and a system for detecting if a shipment passing through an inspection station has been tampered with during shipment.

### BACKGROUND OF THE INVENTION

The United States, Canada and Mexico have recently signed agreements that put in place a “trusted shipper” program in order to allow vehicles that are operated by so-called trusted shippers, and are therefore expected to contain cargoes without contraband or threats to public safety, to cross borders without inspection. If customs inspectors were to have to inspect every truck, this would bring cross-border traffic to a halt. Thus an important problem in implementing the trusted shipper program is how to provide assurance that a vehicle bearing trusted shipper tags is in fact the same vehicle with the same contents that were certified by a trusted shipper when the load was sealed.

Even more broadly stated, the shipping of cargo in containers not only by truck, but also by container ship, or rail, or air transport, is pervasive throughout the world economy. There is a need for an efficient means of certifying that the contents of cargo containers have not been tampered with in transit or in storage, and contain the same cargo with which the container was originally loaded prior to shipping.

The use of tags to seal cargo containers and certify they have not been opened, as signified by a broken tag, is well known in the art. European Patent EP 1182154A1, for example, teaches the use of a numbered metal tag to seal a cargo container. It is also known in the art to identify vehicles by the use of radio-frequency ID (RFID) tags, one example being the EZPass™ system used on the New York State Thruway.

However, while an unbroken cargo seal may establish that a particular seal has not been opened, it provides no identification of that container's contents, save for an ID number. And a metal cargo seal can relatively easily be forged allowing the container to be opened and re-sealed with a forged seal with the same number after items are added to or subtracted from the load.

Similarly an RFID tag on a vehicle or container only identifies that tag. It does not establish that a load has not been tampered by adding or subtracting contents, and the RFID tag also may be moved to a different container. Both these illustrated devices of the prior art may require costly to build and maintain external databases to hold shipping manifest information and verifiable characteristics of the container.

It is also known in the art to attach cargo manifests held in sleeves mounted on shipping containers and also to send the manifest information electronically via e-mail which is in turn linked to or contained within an RFID tag on a vehicle or cargo container. There is, however, no independent proof of the authenticity of this information contained in the paper manifest or the electronically transmitted manifest. Thus there remains a need to provide a seal which cannot be easily counterfeited, along with a supporting system, for a cargo container arriving at an inspection station which both seals the load against tampering and also carries independently verifiable information about the load in human and machine readable form.

### SUMMARY OF THE INVENTION

These and other needs of the prior art are met by the present invention, which in one aspect provides a system for authenticating the identity of a container at an inspection station and for assuring the contents of the container have not been changed during transit, comprising: a copy-protected secure seal tag affixed to the container in such a way that the contents of the container cannot be accessed without altering the seal tag in a detectable way, the seal tag further comprising hidden information containing a unique code pertaining to the container and a specific shipment of the container; and a device enabled to detect the presence of the hidden information in the seal tag and extract and verify the unique access code.

According to another aspect of the present invention, there is also provided a method for authenticating the identity of a container at an inspection station and for assuring the contents of the container have not been changed, comprising the steps of: requesting a unique code from an authorizing agency; incorporating the unique code as hidden information in a secure seal tag; printing the seal tag; affixing the secure seal tag to the container in such a way that the contents of the container cannot be accessed without altering the seal tag in a detectable way; and reading the seal tag at the inspection station with a device enabled to detect the hidden information and extract and verify the access code.

### BRIEF DESCRIPTION OF THE DRAWINGS

In the detailed description of the preferred embodiments of the invention presented below, reference is made to the accompanying drawings in which:

FIG. 1 is a system diagram illustrating the operation of an aspect of the present invention;

FIG. 2 illustrates a seal tag made in accord with the present invention;

FIG. 3 is a system diagram illustrating the operation of an aspect of the present invention;

FIG. 4 depicts a side view of a vehicle inspection station made in accord with the present invention;

FIG. 5 depicts a rear view of the the vehicle inspection station of FIG. 4;

FIG. 6 is a schematic diagram illustrating the operation of one aspect of the present invention;

FIG. 7 is a flowchart illustrating the steps in the overall operation of the present invention; and

FIG. 8 is a continuation of the flowchart of FIG. 7.

### DETAILED DESCRIPTION OF THE INVENTION

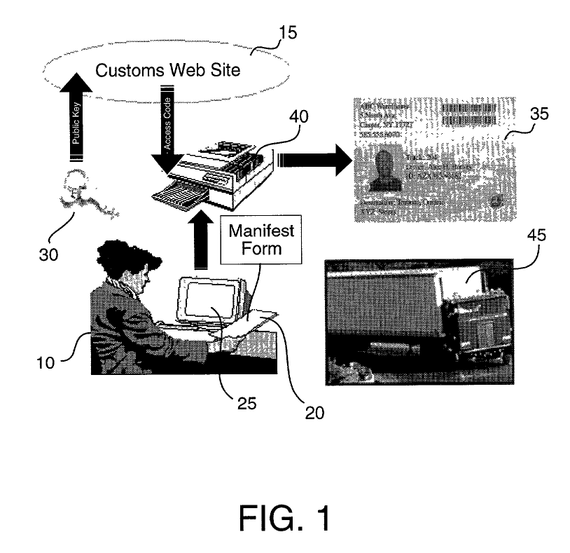

A brief overview of the inception stage of the operation of the present invention will first be described by reference to an example illustrated in FIG. 1. Referring to FIG. 1, a trusted shipper or that shipper's authorized agent 10 first requests a unique code from a secure website 15 operated by an authorizing agency such as the U.S. Customs Department for an anticipated shipment. The request is made by entering the manifest information 20 relative to the anticipated shipment into a computer 25 and then sending this information to the secure web 15 site over a communications network, for example such as the Internet. The issuing agency then returns a unique code (not shown) relating to the specific anticipated shipment to the printer 40. The unique code is then steganographically embedded as hidden information into a trusted shipper seal tag digital image file using techniques well known in the art. The trusted shipper seal tag image file also includes required manifest information and other information such as, for example, weight of the load, time of expected departure and arrival at an inspection station, photo of a truck driver, and the like. The seal tag 35 is then printed using a local printer 40 on a security paper with a pressure sensitive adhesive back. The seal tag 35 is affixed to a truck 45 after the truck has been loaded, for example by sealing across the rear doors in a way that indicates if the doors have been opened during transit. Such secure seal tags, which are tamper-evident, are well known in the art. For example, a secure seal tag such as that supplied by CGM Security Solutions, 223 Churchill Avenue, Somerset, N.J. is particularly useful for the practice of this invention. Attempts to remove or alter these tags, results in the appearance of an obvious visible pattern. A duplicate seal tag may also be placed on the side of the truck.

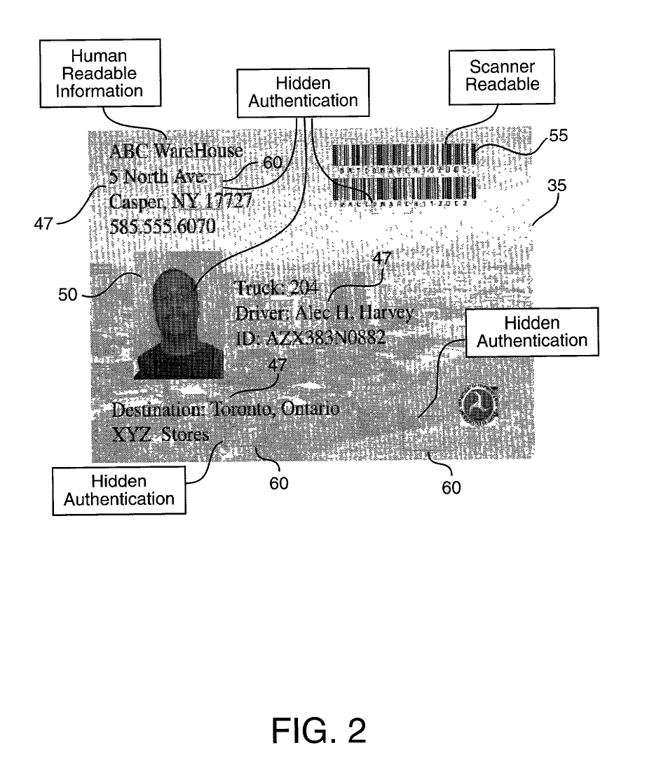

FIG. 2 depicts an enlargement of the seal tag 35 of FIG. 1. Note that the seal tag 35 contains human readable information 47 such as the name of the shipper, truck identification information, driver's name and ID, destination of the shipment, etc., a photograph of a driver 50 which is available to be compared to the actual driver of the truck, again at an inspection station by an inspector, and machine readable information 55 that can be read with an appropriate scanner, for example, such as a barcode scanner reading barcodes, at an inspection station. Also dispersed throughout the image is hidden information 60 which holds the correct unique code issued by the authenticating agency for this particular shipment, driver and load. The presence of hidden information 60 authenticates that this is both a legitimate tag and that it is attached to the correct truck with the correct load and driver. Methods of creating such hidden information 60 in a digital image, sometimes also known as a “digital watermark”, are well known in the art. The method described in commonly assigned U.S. Pat. No. 6,044,156, to Honsinger and Rabbani, employs steganographic techniques for creating hidden information in a digital image and is particularly useful for the practice of the present invention. The '156 patent is hereby incorporated by reference in its entirety. Hidden information 60 inserted by the method of the U.S. Pat. No. 6,044,156 is very robust and can be easily read even if the image is partially obscured. Thus, for example, if the seal tag 35 had been splashed with mud or perhaps had been partially damaged in some other way during shipment, it would still be possible to extract the hidden information 60.

A drawback of such a seal tag 35 with hidden information 60 is that it is possible to make a counterfeit seal tag by first electronically scanning the original and then printing a copy. Hidden information inserted steganographically by the method of the '156 patent are actually part of the image itself since the hidden information is actually a sub-visible pattern imposed on the noise in the image and, as such, may be copied along with the image by electronic scanning. Thus a container might be diverted in transit, the original seal tag scanned and then destroyed to allow the container to be opened, the contents to be substituted and, finally, to be resealed with a counterfeit tag which still contains the proper steganographically embedded hidden information unique code information. To prevent counterfeiting of a seal tag and make it copy-protected, the embedded hidden information 60 may be further linked to the particular piece of print media upon which it is printed. Commonly assigned U.S. patent application Ser. No. 09/930,634, filed Aug. 15, 2001, by Patton, et al., incorporated herein by reference, discloses a method of linking steganographically embedded hidden information in an image to a unique characteristic of a sheet of print media. If a seal tag is made with the hidden information 60 containing the unique code so linked to the medium on which it is printed, then it will not be possible to simply copy the seal tag by scanning and printing because the medium on which the copy is printed is linked to the hidden information 60 containing the unique code in a such manner that the unique code is only extractable if it is written on a particular piece of security media as described by Patton, et. al.

Yet another feature which may be introduced to further enhance the security of the seal tag 35 is to further encrypt the information contained in it. A number of encryption methods can be used for this purpose, including the well-known public key/private key encryption scheme. Using the public key/private key encryption method, a user encrypts information using the public key, which is available to anyone. The information, however, may be decrypted only by those in possession of the private key. A complete description of the public key/private key encryption methodology may be found in Public Key Cryptography Standards Document #1 v2.1, published by RSA Security, Inc, 174 Middlesex Turnpike, Bedford, Mass. For the purposes of the present invention, the trusted shipper or his agent 10 would supply the public key (30, FIG. 1) along with the manifest information 20 to the authorizing agency's website 15 and this public key would be used along with the agency's private key to encrypt the unique code and/or the other manifest information. The encrypted information is thus protected from interception when it is transmitted back to the authorized agent 10. Furthermore if the encrypted version of the unique code is embedded as the hidden information 60 in the seal tag 35, then if an unauthorized person were able to extract the hidden information 60, he still would be unable to read it.

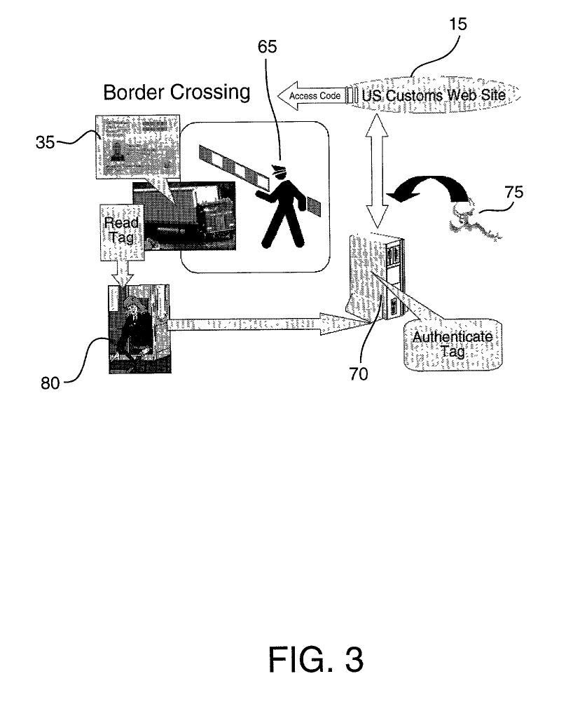

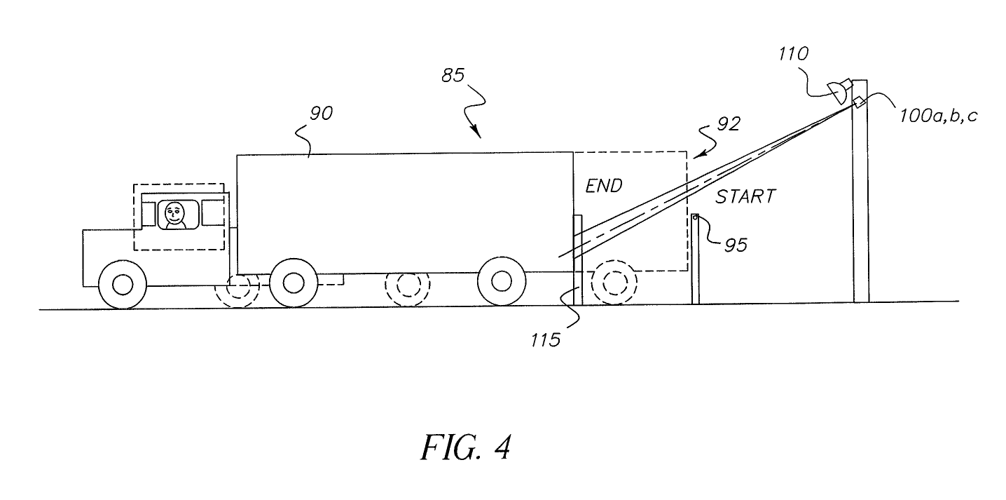

Turning now to the operation of the invention at an inspection station, as shown in FIG. 3, an operator 65 first visually ascertains that the seal tag 35 has not been broken and then captures an image of the seal tag/label 35 using a digital camera, or cameras (not shown, see FIGS. 4-6 later). Next, the hidden information is extracted from the image of the seal tag and the unique code then derived from it, decrypting it first if necessary. Methods of detecting and extracting a hidden information, which has been embedded in a digital image are disclosed in the previously cited, and incorporated'156 patent and also in the commonly assigned and co-pending U.S. patent application Ser. No. 09/505,327, filed Feb. 16, 2000, by Honsinger, which is hereby also incorporated in its entirety by reference. The unique code is entered into a computer 70 where it is first decrypted if necessary, using the private key 75 of the authorizing agency, and then compared to the legitimate unique code, which is stored by the authorizing agency, for example on a secure website 15, or other secure computer storage is facility. A matching comparison provides verification of the seal tag's authenticity. Manifest information such as the truck's weight can also be read from the seal tag 35 at a scanning station 80. If the information matches and is unaltered the truck is allowed to pass. This validation all takes place in a short time and is able to be carried out even while the truck is still moving slowly.

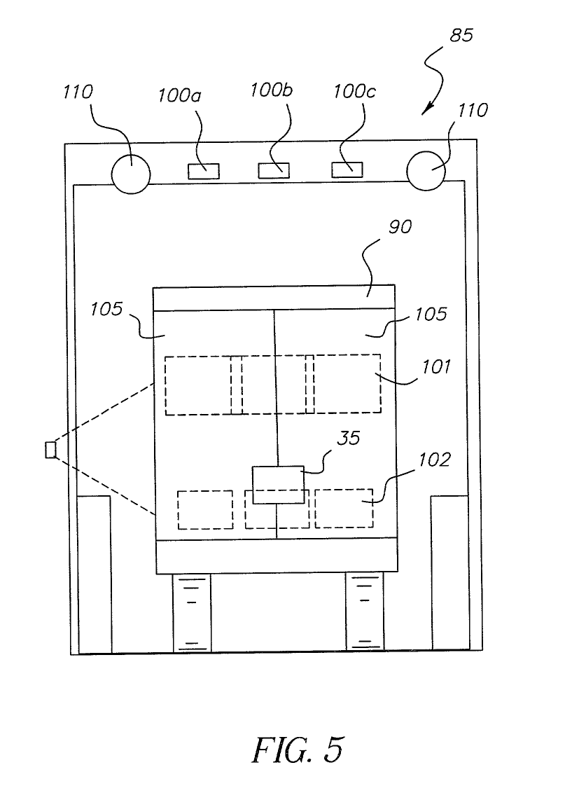

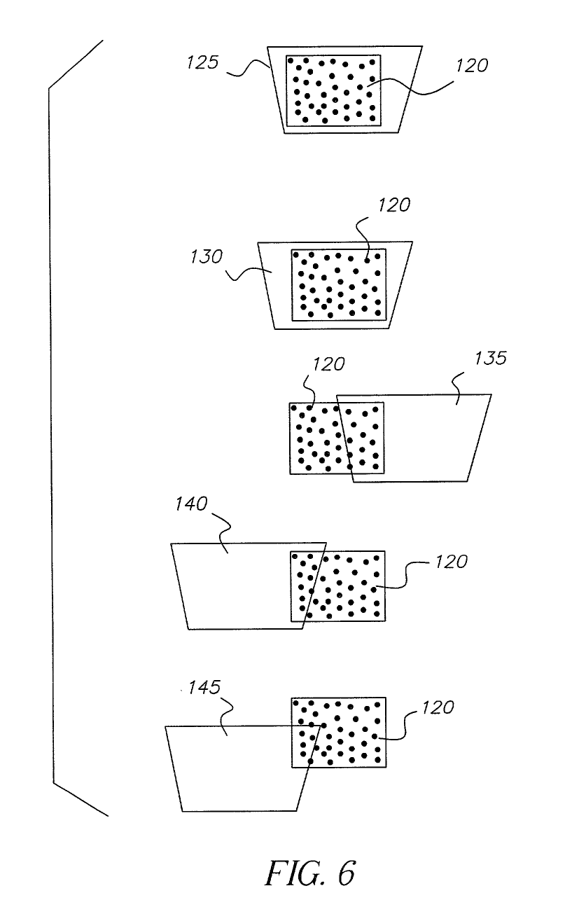

The operation of the invention with respect to detecting and extracting the hidden information from a secure seal tag on a container in motion is now described in detail by reference to FIGS. 4-6. Referring first to FIGS. 4 and 5, there are shown side and rear views respectively of inspection station 85 with a truck 90 moving through the station 85 slowly. As the rear 92 of the truck 90 passes sensor 95, pole-mounted digital cameras 100a, 100b and 100c are activated to begin to capture digital images of the rear doors 105 of truck 90. The lights 110 are used to provide sufficient light for photographing after dark. Since only a limited area can be covered by a single camera for sufficient resolution of the embedded hidden information, multiple cameras 100a, 100b and 100c are aimed and aligned to cover all areas of the truck rear doors 105 where seal tag 35 is likely to be placed, taking into account variations in truck size and that the seal tag 35 may not always be positioned at the same point on doors 105. As the truck 90 moves away from the cameras 100a-c, the field of view of the cameras changes. The position of the initial exposures 101 are of directed to an area on the rear doors 105 above the location of the seal tag 35; as the truck 90 moves away from cameras 100a-c, the area captured moves progressively down the back of the rear doors 105 until, when the rear 92 of truck 90 has reached the second sensor 115, the cameras 100a-c are shut off. The alignment and placement of components within the inspection station 85 is such that position of the final exposures 102 will be directed to an area below seal tag 35. The pole mounted sensors 95 and 115 are spaced and the cameras parameters set so there is sufficient resolution in the images to detect any hidden information present, as specified in the U.S. patent application Ser. No. 09/505,327 and to decipher the data present, as disclosed in the '156 patent. Referring to FIG. 6, the fields of view 120 represent the fields of view 120 of one of the cameras, 100a-c while the trapezoids 125, 130, 135, 140 and 145 represent examples of the appearance of the seal tag 35 from the point of view of the various cameras at various truck-to-camera distances. For example, trapezoid 125 represents the appearance of seal tag 35 with respect to the field of view 120 of camera 100b (the center camera) and illustrates a case when the field of view of the camera 100b and the seal tag 35 are substantially congruent. Trapezoid 130 illustrates the appearance of seal tag 35 with respect to field of view 120 of camera 100b where the degree of alignment does not fully encompass the seal tag 35. Continuing with the illustrative examples, trapezoid 135 represents the appearance of seal tag 35 with respect to left hand camera 100a where there is only partial overlap and trapezoid 140 represents the appearance of seal tag 35 with respect to right hand camera 100c, again with partial overlap. Finally trapezoid 140 represents the appearance of seal tag 35 by camera 100c where the overlap is only slight overlap. It will be understood however, that any of these examples of overlap may be adequate for the extraction of the embedded hidden information, since as disclosed by Honsinger in the previously cited '156 patent, the hidden information is redundant, as it is written many times on a single tag, for example in a tiled manner. The distortion in the image introduced by photographing the seal tag 35 at an angle may be corrected by any of a number of methods, well known in the art, of correcting geometric distortion in a digital image. Images may be analyzed as they are being made, or together as a batch after the sequence of images have all been captured. The code is extracted from the hidden information detected in the images by the method of Honsinger in the '156 patent. The cameras continue to photograph until the truck either reaches end sensor 115 or an image is detected where the hidden information is successfully detected and interpreted.

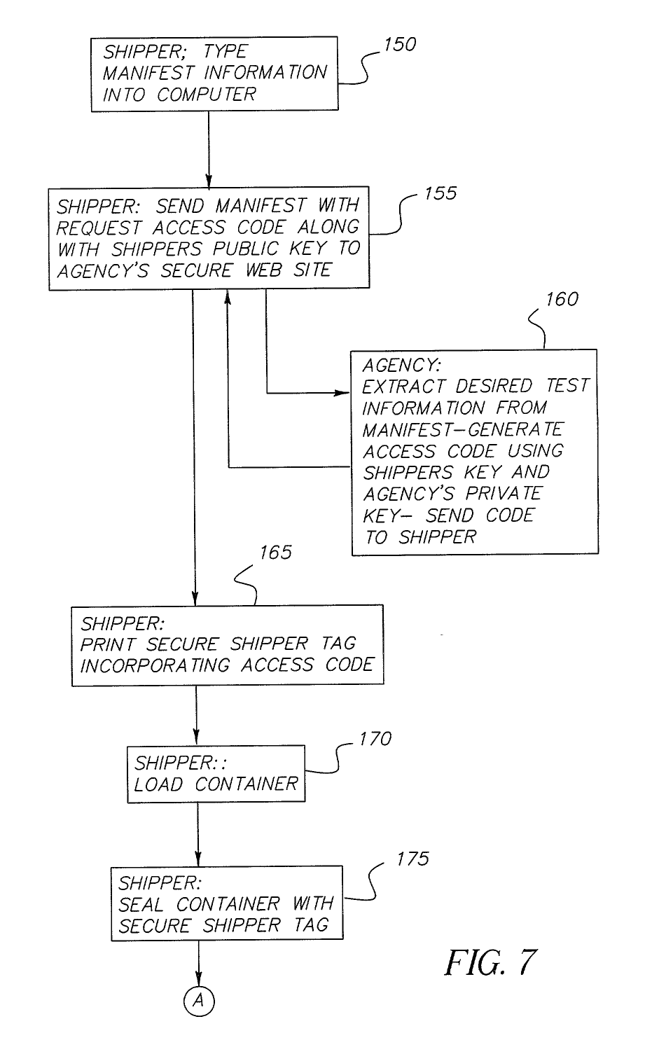

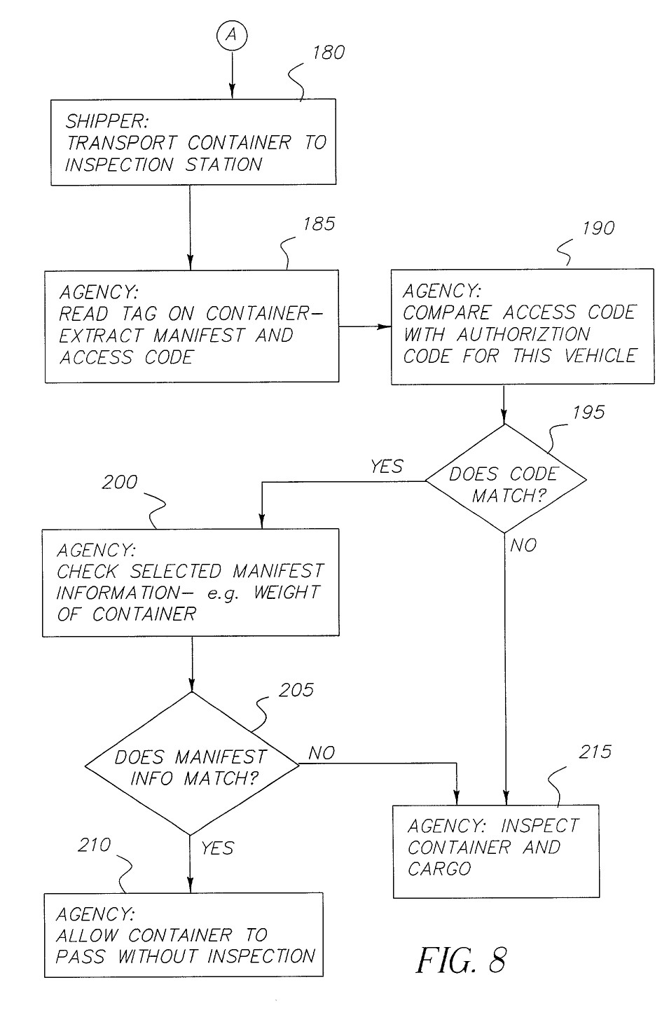

In order to provide a better understanding of the present invention, the steps required for its detailed overall operation will now be described in an operational flow chart presented in FIGS. 7 and 8. It will be understood that the system whose overall operation is described in FIGS. 7 and 8 is the same system described earlier by the system diagrams of FIGS. 1, 3 and 4-6. Beginning in FIG. 7, at step 150, a trusted shipper first enters manifest information for the particular shipment into his computer. Manifest information may include any or all of the following items: truck or vehicle type and registration, nature of shipped items and weight, date and destination of shipment, driver's name, driver's picture, and/or other driver ID information. Next, in step 155, the shipper transmits a request for a unique code along with the manifest information and the shipper's public encryption key to an authorizing agency's secure web site. Transmission of the data may be over any communication channel such as the Internet or a telephone line. In step 160 the authorizing agency extracts and records important data from the manifest information and also returns the unique code to the shipper which is accepted by the printer driver software and embedded as hidden information in the digital representation of the secure shipper seal tag as described previously. The shipper then prints the tag (step 165) including human and machine readable versions of the manifest information and the hidden information. After the container (for example a truck trailer or shipping container) has been loaded in step 170 while being observed by the trusted shipper personnel, the shipping container is sealed (step 175) in a designated location on the container such that attempts to open the container would result in a visual alteration of the seal. Continuing with the process in FIG. 8 at point A, the container is next transported (step 180) to an inspection station, such as, for example, a border crossing or port of entry. It will be understood that inspection of containers is not limited to times when they are crossing a border or entering a port, but may also be inspected at other times during transit or anywhere the appropriate equipment is available. The seal tag integrity is confirmed by the inspector who also scans (step 185) the seal tag with an appropriate scanner to extract machine readable information. A digital camera captures an image of the seal tag, detects the presence of any hidden information and extracts the unique code. The unique code is compared in the authorizing agency's computer (step 190) with the unique code which had been sent for this container and shipment. If the unique code matches (decision step 195) the agency may check selected manifest (step 200) information (such as the weight of the vehicle, driver's ID, etc) as additional proof of the integrity of the load. If there is a match (decision step 205) the vehicle is allowed through the checkpoint without further inspection (step 210). If either test is failed the inspector my open the vehicle and inspect the cargo (step 215).

The invention has been described in detail with particular reference to certain preferred embodiments thereof, but it will be understood that variations and modifications can be effected within the scope of the invention.

### PARTS LIST

10 authorized agent

15 secure website

20 shipping manifest information

25 computer terminal

30 public key

35 seal tag

40 printer

45 truck

47 human readable information

50 driver's photograph

55 machine readable information

60 hidden information

65 operator

70 computer

75 private key

80 scanning station

85 inspection station

90 truck

92 rear of truck

95 sensor

100a-c digital cameras

101 position of initial exposures

102 position of final exposures

105 rear truck doors

110 light

115 sensor

120 field of view

125 appearance of tag

### PARTS LIST CONTINUED

130 appearance of tag

135 appearance of tag

140 appearance of tag

145 appearance of tag

150 step

155 step

160 step

165 step

170 step

175 step

180 step

185 step

190 step

195 step

200 step

205 step

210 step

215 step

What is claimed is:

1. A system for authenticating the identity of a container at an inspection station and for assuring the contents of said container have not been changed during transit, comprising:
a) a copy-protected secure seal tag affixed to said container in such a way that said contents of said container cannot be accessed without altering said seal tag in a detectable way, said seal tag further comprising hidden information containing a unique code pertaining to said container and a specific shipment of said container; and
c) a device enabled to detect the presence of said hidden information in said seal tag and extract and verify said unique code.

2. The system according to claim 1 wherein said copy-protected secure seal tag also contains human and/or machine readable information related to said shipment.

3. The system according to claim 1 wherein said copy-protected secure seal tag further comprises means to indicate when said copy protected secure seal tag has been tampered with.

4. The system according to claim 2 wherein said human and/or machine readable information further comprises information with respect to at least one item selected from the following list: vehicle type and registration, nature of shipped items and weight, date and destination of shipment, driver's name, driver's picture or other driver ID information.

5. The system of claim 1 wherein said unique code is obtained from an authorizing agency.

6. The system of claim 4 wherein said unique code is sent from said authorizing agency in an encrypted form over a communications network.

7. The system of claim 1 wherein said copy-protection of said seal tag is accomplished by printing said seal tag on security media.

8. The system of claim 6 further comprising said security media having a unique identifying characteristic, said identifying characteristic being linked to said hidden information.

9. The system of claim 1 wherein said device enabled to detect the presence of said hidden information in said seal tag and extract and verify said unique code further comprises:
a) at least one digital camera enabled to capture at least one image of said seal tag; and
b) computer processing means loaded with appropriate software to process and analyze said at least one captured image for the presence of said hidden information and extract said unique access code.

10. The system of claim 1 wherein said device enabled to detect the presence of said hidden information in said seal tag and extract and verify said unique access code, further comprises means to read said hidden information while said container is moving relative to said device.

11. The system of claim 10 wherein said means to read said hidden information while said container is moving relative to said device further comprises:
a) at least one digital camera is mounted in an inspection station and aimed at a region on said container where said seal tag is mounted, said at least one camera enabled to capture a series images of said seal tag as said container moves through said inspection station; and
b) computer processing means loaded with appropriate software to process and analyze said captured series of image for the presence of said hidden information and extract said unique code.

12. A method for authenticating the identity of a container at an inspection station and for assuring the contents of said container have not been changed, comprising the steps of:
a) requesting a unique code from an authorizing agency;
b) incorporating said unique code as hidden information in a secure seal tag;
c) printing said seal tag;
d) affixing said secure seal tag to said container in such a way that said contents of said container cannot be accessed without altering said seal tag in a detectable way; and
e) reading said seal tag at said inspection station with a device enabled to detect said hidden information and extract and verify said unique code.

13. The method according to claim 12 further comprising a step of incorporating human and/or machine readable information in said seal tag.

14. The method of claim 12 further comprising a step of sending said unique code by said authorizing agency in an encrypted form.

15. The method of claim 12 wherein said step of printing said seal tag further comprises printing said seal tag on security media.

16. The method of claim 12 wherein said security media further comprises a unique identifying characteristic, said identifying characteristic being linked to said unique code incorporated in said hidden information.

17. The method of claim 12 wherein said step of reading said seal tag at said inspection station with a device enabled to detect said hidden information and extract and verify said unique code, further comprises the steps of:
a) capturing at least one image of said seal tag by at least one digital camera; and
b) analyzing said at least one captured image by computer processing means for the presence of said hidden information, and extracting said unique code.

18. The method of claim 12 wherein said step of reading said seal tag at an inspection station further comprises reading said hidden information from said seal tag while said container is moving relative to said device.

19. The method of claim 18 wherein said step of reading said hidden information while said container is moving relative to said device further comprises the steps of:
a) capturing a series of images of said seal tag while said container moves through an inspection station, said series of images being captured by at least one digital camera mounted in said inspection station and aimed at a region on said container where said seal tag is mounted; and
b) analyzing said captured series of images by computer processing means for the presence of said hidden information, and extracting said unique code.
